(19) United States
(12) Patent Application Publication
(10) Pub. No.: US 2025/0305971 A1
(43) Pub. Date: Oct. 2, 2025

(54) X-RAY METHODS AND SYSTEMS FOR SEMICONDUCTOR SUBSTRATE ALIGNMENT

(71) Applicant: Tokyo Electron Limited, Tokyo (JP)

(72) Inventors: Francisco Machuca, Fremont, CA (US); Xinkang Tian, Fremont, CA (US); Shuyan Zhang, Fremont, CA (US)

(21) Appl. No.: 18/620,463

(22) Filed: Mar. 28, 2024

(51) Int. Cl. G01N 23/223; G01N 23/041

(52) U.S. Cl. CPC G01N 23/223; G01N 23/041; G01N 2223/076; G01N 2223/1016

(57) ABSTRACT

X-rays are directed to a first substrate and to a second substrate in a bonding configuration for bonding together. The X-rays are directed to first and third alignment marks in the first substrate and to second and fourth alignment marks in the second substrate. Fluorescent X-rays are detected upon emission from the first alignment mark and the second alignment mark to measure a first misalignment of the first substrate with respect to the second substrate based on a first detected misalignment of the first and second alignment marks. X-rays transmitted through the first and second substrates using X-ray Talbot-Lau interferometry to measure a second misalignment of the first and second substrates based on a second detected misalignment of the third and fourth alignment marks.

### TECHNICAL FIELD

The present disclosure relates generally to semiconductor fabrication, and, in particular implementations, to X-ray methods and systems for semiconductor substrate alignment.

### BACKGROUND

Generally, a semiconductor integrated circuit (IC) is fabricated by sequentially depositing conductive, dielectric, and semiconductor layers over a semiconductor substrate to form IC devices. Semiconductor processing includes patterning layers using photolithography and etch to form electronic and interconnect elements like transistors, resistors, capacitors, metal lines, contacts, and vias in one monolithic structure.

The semiconductor industry has traditionally followed Moore's Law, which was initially based on the observation that the number of transistors on a chip doubles approximately every two years, leading to a cadence of shrinking feature sizes (also referred to as “scaling”) along with improvements in performance and reductions in costs. However, as transistor features approached atomic dimensions, maintaining this pace has become increasingly challenging. As a result, the scaling cadence has evolved from a strict focus on feature size reduction to a more complex progression incorporating innovations in 3D structures, new materials, and integration methods.

The advancement toward miniaturization in semiconductor technology has been a driving force behind the development of sophisticated 3D integration techniques such as wafer-to-wafer (W2 W), die-to-die (D2D) bonding, die-to-wafer (D2 W) bonding, along with multi-die stacking, such as in dynamic random access memory (DRAM) having up to 16 layers or more. The success of 3D integration processes can be contingent upon a precise alignment of components to provide good electrical performance and mechanical anchoring, such as to support high density interconnect schemes. Such precise alignment using traditional optical alignment methods can become increasingly difficult to perform, particularly when dealing with opaque materials presented by thick substrate layers of doped silicon (Si) and multiple metallized copper layers.

### SUMMARY

In one aspect, a first method of measuring misalignment between substrates is disclosed. The first method includes directing X-rays to a first substrate and to a second substrate in a bonding configuration prior to bonding together, the directing including directing the X-rays to a first alignment mark and to a third alignment mark in the first substrate and to a second alignment mark and to a fourth alignment mark in the second substrate. The first method also includes detecting fluorescent X-rays emitted from the first alignment mark and from the second alignment mark to measure a first misalignment of the first substrate with respect to the second substrate based on a first detected misalignment of the first alignment mark with respect to the second alignment mark, and detecting at least some of the X-rays transmitted through the first substrate and through the second substrate using X-ray Talbot-Lau interferometry to measure a second misalignment of the first substrate with respect to the second substrate based on a second detected misalignment of the third alignment mark with respect to the fourth alignment mark.

In another aspect, a second method of measuring misalignment between substrates is disclosed. The second method includes directing X-rays to a first substrate and to a second substrate in a bonding configuration prior to bonding together, the directing including directing the X-rays to a first alignment mark in the first substrate and to a second alignment mark in the second substrate, detecting fluorescent X-rays emitted from the first substrate and from the second substrate in response to the X-rays irradiating the first alignment mark and the second alignment mark, and measuring a first misalignment of the first alignment mark with respect to the second alignment mark based at least in part on a wavelength of the fluorescent X-rays corresponding to a metal in the first alignment mark and in the second alignment mark.

In yet another aspect a third method of measuring misalignment between substrates is disclosed. The third method includes directing X-rays to a first substrate and to a second substrate in a bonding orientation for subsequent bonding to each other, and transmitting the X-rays through a first alignment mark in the first substrate and through a second alignment mark in the second substrate using an X-ray Talbot-Lau interferometer. In the third method, the first alignment mark and the second alignment mark comprise a first Moiré interferometric grating pair. The third method also includes measuring a first misalignment of the first substrate with respect to the second substrate based on detecting a first detected misalignment of the first alignment mark with respect to the second alignment mark using a first interferometric pattern and a second interferometric pattern associated with the first Moiré interferometric grating pair, the detecting the first detected misalignment including measuring a first displacement of the first interferometric pattern in a first direction and a second displacement of the second interferometric pattern in a second direction opposite the first direction.

In any of the disclosed implementations, the third method can include transmitting the X-rays through a third alignment mark in the first substrate and a fourth alignment mark in the second substrate using the X-ray Talbot-Lau interferometer In the third method, the third alignment mark and the fourth alignment mark can comprise a second Moiré interferometric grating pair. The third method can also include measuring a second misalignment of the first substrate with respect to the second substrate based on measuring a second detected misalignment of the third alignment mark with respect to the fourth alignment mark using a third interferometric pattern and a fourth interferometric pattern associated with the second Moiré interferometric grating pair, the measuring the second detected misalignment including measuring a third displacement of the third interferometric pattern in the first direction and a fourth displacement of the fourth interferometric pattern in the second direction.

In a further aspect, a fourth method of measuring misalignment between semiconductor substrates is disclosed. The fourth method includes transmitting first X-rays, using an X-ray Talbot-Lau (TL) interferometer, through a first substrate and through a second substrate in a bonding configuration for subsequent bonding to each other, including transmitting the first X-rays through a first alignment mark in the first substrate and through a second alignment mark in the second substrate to generate second X-rays, and transmitting the second X-rays through a TL phase grating and through a TL analyzer grating to generate third X-rays. The fourth method also includes receiving the third X-rays at an X-ray detector to measure a first misalignment of the first substrate with respect to the second substrate based on detecting a first detected misalignment of the first alignment mark with respect to the second alignment mark using the X-ray detector.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a depiction of a dual X-ray measurement system, in some implementations;

FIG. 2 is a depiction of an X-ray transmission measurement system using Talbot-Lau (TL) interferometry, in some implementations;

FIG. 3 is a depiction of composite alignment marks for a semiconductor substrate, in some implementations;

FIGS. 4A, 4B, and 4C depict an X-ray fluorescence (XRF) misalignment detection process, in some implementations;

FIGS. 5A, 5B, and 5C depict an X-ray transmission misalignment detection process, in some implementations;

FIGS. 6A, 6B, and 6C, depict Moiré-fringe alignment marks for a semiconductor substrate, in some implementations;

FIGS. 7A and 7B, depict Moiré-fringe X-ray transmission alignment images, in some implementations;

FIG. 7C is a calibration plot for Moiré interferometric patterns, in some implementations;

FIGS. 8A, 8B and 8C depict Moiré-fringe alignment marks for a semiconductor substrate, in some implementations;

FIG. 8D is a calibration plot for Moiré interferometric patterns, in some implementations;

FIG. 9 is a flowchart depicting a method of aligning two semiconductor substrates using X-ray alignment methods and systems, in some implementations;

FIGS. 10A and 10B are depictions of multi-layer Moiré-fringe alignment marks, in some implementations;

FIG. 11 is a flowchart depicting a method of alignment measurement, in some implementations;

FIG. 12 is a flowchart depicting a method of alignment measurement, in some implementations; and

FIG. 13 is a flowchart depicting a method of alignment measurement, in some implementations.

### DETAILED DESCRIPTION

This disclosure describes X-ray methods and systems for semiconductor substrate alignment, such as for aligning two or more semiconductor substrates for a 3D bonding process, in various implementations.

In the following description, details are set forth by way of example to facilitate discussion of the disclosed subject matter. It will be apparent to a person of ordinary skill in the field, however, that the disclosed implementations are exemplary and not exhaustive of all possible implementations.

Throughout this disclosure, a hyphenated form of a reference numeral refers to a specific instance of an element and the un-hyphenated form of the reference numeral refers to the element generically or collectively. Thus, as an example (not shown in the drawings), device “12-1” refers to an instance of a device class, which may be referred to collectively as devices “12” and any one of which may be referred to generically as a device “12”. In the figures and the description, like numerals are intended to represent like elements.

As noted above, the semiconductor industry has embraced 3D packaging to provide hybrid devices, such as that stack bonded die together and mix different technology nodes in a single final product for economic benefits. In some applications, such 3D ICs are fabricated using W2 W bonding that produces multiple 3D ICs or chips in a single operation for economical reasons, which can then be sliced apart from the bonded wafers. The W2 W bonding process, therefore, also includes alignment of the wafers to each other such that the W2 W bonding results in each 3D IC formed on the wafers being bonded together in an aligned manner within specified tolerances. In other applications, D2 W bonds are used to bond individual die to wafers, which also involves precise alignment for successful 3D IC fabrication, similarly as D2D bonds to bond individual die together.

Accordingly, W2 W, D2 W, and D2D bonding techniques can serve to form a surface bond between two semiconductor parts. The bonding surfaces may be prepared to facilitate a bond having sufficient bond strength, such as by planarizing each surface to be bonded. In various embodiments, CMP and other surface treatments may be used to prepare the part surfaces to be bonded together, among other processing steps. The part surfaces on a wafer to be bonded with another wafer can comprise metals, semiconductors, dielectrics, polymers, or other materials, in various implementations.

Specifically, in the case of forming 3D ICs using W2 W, D2 W, or D2D bonding, some or all layers of the IC devices formed on each wafer can be completed before the bonding is performed. For example, certain back-end of line (BEOL) layers that can include conductors, barrier layers, and dielectric insulators may comprise numerous numbers of layers, which, in combination with the multiple layers of front-end-of-line (FEOL) portions of the IC, can result in different types of adjacent materials being subject to the alignment process, and thus, potentially interfering with the alignment process, in particular when visible or IR light is used.

Typical alignment systems and process often use near infrared (NIR) radiation, which can have difficulty penetrating thick Si, or highly doped Si, and may not pass through metal layers. Moreover, NIR can be depth of field (DoF) limited when used in high resolution and high magnification optical path system. For example, some typical NIR alignment systems can provide magnification levels of 10×-50× and can accordingly align semiconductor substrates to within tolerance ranges of about ±3 μm to ±6 μm. At such magnifications, the focal plane adjustment for best focus may not correspond with locations of device features to be aligned, and can so result in systematic shift errors accumulating in total measurement uncertainty (TMU) that can exceed acceptable tolerances of the process metrology. Therefore, the capability to measure 3D bonded substrate alignments through materials that are not transparent to optical wavelengths and metallization layers that are not part of the alignment marks but part of the active devices, is desirable and may be difficult or impossible using conventional NIR radiation and associated alignment techniques.

Recent technological developments in semiconductor optical light-based alignment systems have demonstrated the use of Moiré fringe-based alignment techniques, which can offer greater alignment resolution due to their capability to magnify the misalignment with Moiré gratings in the optical path. In this manner, Moiré fringe-based alignment interferometric patterns provide X-ray magnification that can be used to detect smaller misalignments than could be detected with a conventional image-based overlay (IBO) metrology tool.

As will be disclosed in further detail herein, X-ray methods and systems for semiconductor substrate alignment are disclosed that overcome potential limitations of using NIR light. Furthermore, methods and systems for integrating Moiré fringe-based alignment techniques with small angle scatter (dark field) and phase contrast based X-ray techniques for W2 W, D2 W, or D2D bonds are disclosed. In particular implementations, a Talbot-Lau (TL) grating-based X-ray interferometry can be used together with X-ray fluorescence (XRF) to provide a dual measurement strategy using a single substrate alignment system, such as for D2D and D2 W bonds. The dual TL-grating and XRF methods being integrated into a single system can improve alignment precision and provide process versatility in semiconductor manufacturing for 3D integration for advanced packaging. For example, both TL-grating and XRF methods can be used in the same field of view (FOV) for simplified alignment of D2D and D2 W bonds using different methods for different spatial resolutions, which can simplify typical methods that may use different types of optics and focal arrangements that involve certain reconfiguration and setup operations for different FOVs.

Certain implementations of X-ray methods and systems for semiconductor substrate alignment disclosed herein provide an alignment mark design that is tailored for X-ray analysis methods. In certain implementations, both TL-grating and XRF methods can be used in a single FOV, such as for high-precision overlay and highly sensitive misalignment measurements in D2D and D2 W bonding processes. In certain implementations, the X-ray TL-grating methods can simultaneously produce different imaging modalities for comprised of transmission absorption imaging (IBO), dark field or small angle scatter (IBO) in real space, and phase contrast imaging (IBO), such as for W2 W, D2 W, and D2D bonding. The alignment marks can be formed using copper (Cu) or other metals, and can define finely spaced alignment marks corresponding to the metal (e.g., Cu) pads in wafer bonding. Certain implementations, thus, can provide improved precision, lower detection limits for misalignment, and linearity in magnification for alignment mark detection and measurement. Certain implementations can provide different locations for in situ integration with bonding machines and bonding processes, such as for process-integrated metrology that generates local feedback to pre- and post-alignment checks. Certain implementations can be used in the form of stand-alone metrology tools for bonding inspection, among other applications.

Accordingly, certain implementations provide a unitary alignment mark design that fits into a common FOV and serves in both coarse alignment and fine alignment steps. In certain implementations, the unitary alignment mark design can conserve substrate area by eliminating duplicate or different types of alignment marks for coarse and fine alignment steps. Due to the unitary alignment mark design that is compatible with the dual X-ray measurement techniques (TL-grating and XRF methods), certain implementations can reduce or eliminate reference errors and re-focus adjustment lateral error that can otherwise add unwanted TMU, such as for D2D and D2 W bonds, which is desirable. Certain implementations can support the fine alignment steps by including a high precision target design with the unitary alignment mark design, thereby achieving an alignment accuracy of at least 20 nm and a target precision of 10% of the accuracy or less, with as much as 99% linearity over the measurement range.

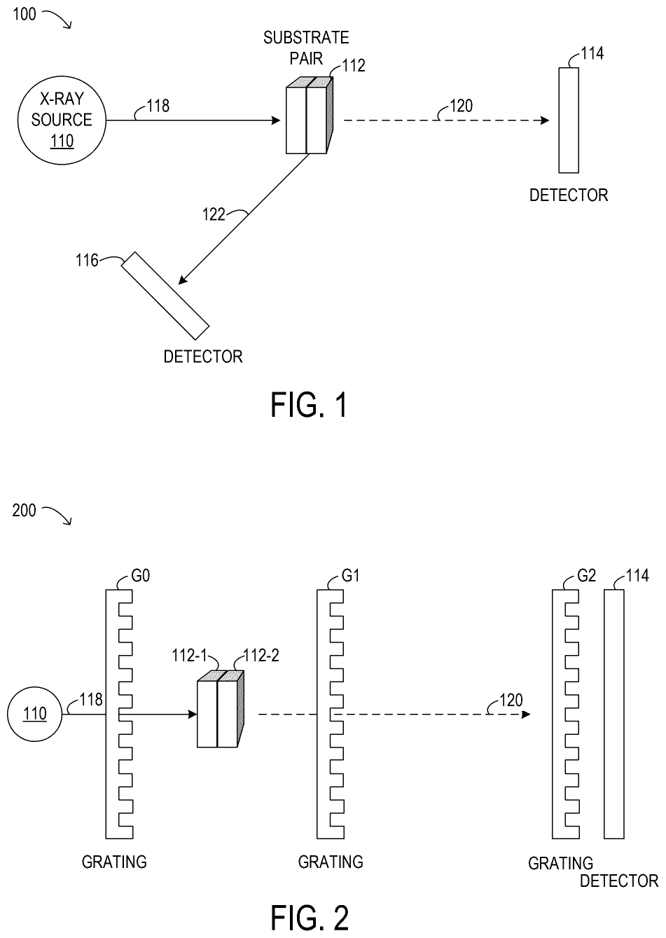

Turning now to the drawings, FIG. 1 is a depiction of a dual X-ray measurement system 100 (or simply system 100). FIG. 1 is a schematic illustrate and is not necessarily drawn to scale or perspective. Certain elements are omitted in FIG. 1 for descriptive clarity.

As shown system 100 in FIG. 1 comprises an X-ray source 110 that can output an X-ray beam 118 towards a substrate pair 112. X-ray beam 118 can comprise incoherent X-rays or coherent X-rays having a defined frequency, wavelength, and phase. Substrate pair 112 can represent a test sample or a test object and comprises two semiconductor substrates that are to be bonded, such as a first substrate and a second substrate. In various implementations, substrate pair 112 can be subject to analysis and measurement of misalignment to each other using system 100, as described in further detail herein. In particular implementations, substrate pair 112 can be used with system 100 in a bonding process prior to bonding, such as when the first substrate and the second substrate are held in a fixture in proximity to each other and are in a process of pre-bonding alignment.

Accordingly, system 100 also includes a first detector 114 that receives transmitted X-ray beam 120 from substrate pair 112 and includes a second detector 116 that receives backscattered X-rays 122 from substrate pair 112. As shown, backscattered X-rays 122 can comprise fluorescent X-rays that are emitted from substrate pair 112 in response to irradiation of substrate pair 112 by X-ray beam 118. When the atoms in the substrate pair 112 absorb the energy from the irradiating X-ray beam 118, their electrons are ejected from the inner shells (typically the K or L shells). Eventually, the electrons from higher energy levels (outer shells) fall into the lower energy vacancies. As an electron transitions from a higher energy level to a lower one, energy is released in the form of fluorescent X-rays. The emitted fluorescent X-rays have characteristic energies that are specific to each element. There are two main methods for measuring these X-rays: Energy Dispersive X-ray Fluorescence (EDXRF) and Wavelength Dispersive X-ray Fluorescence (WDXRF). EDXRF uses a semiconductor detector to directly measure the energy of the incoming fluorescent X-rays, thereby discerning different elements. WDXRF uses a crystal to disperse the X-rays onto a detector according to their wavelength, with detectors then measuring their intensity.

Accordingly, in various embodiments, second detector 116 can be an X-ray fluorescence (XRF) detector, such as a Silicon Drift Detector (SDD) that can measure energy (wavelength) and intensity of incident X-ray photons in backscattered X-rays 122. A Silicon Drift Detector (SDD) is an Energy Dispersive X-ray Fluorescence (EDXRF) detector. Second detector 116 can comprise a high-purity silicon wafer that acts as the detection material. When X-rays enter the silicon wafer, they interact with the silicon atoms and generate electron-hole pairs proportional to the energy of the X-rays. The wafer has a series of ring-shaped electrodes, or drift rings, on its surface. These are concentrically arranged around a small collection anode in the center. The rings create a potential gradient when voltage is applied, which ensures that the generated charge carriers (electrons) drift towards the center. The charge carriers that are created by the interaction of X-rays with the silicon wafer drift towards the collection anode due to the presence of an electric field. A Field-Effect Transistor (FET) is coupled to the collection anode at the center of the silicon wafer. This FET amplifies the signal generated by the incident X-rays as soon as the charges arrive at the collection anode. After initial amplification, the signal goes through further processing stages, where it is shaped, amplified, and converted into a digital signal. The energy of each incident X-ray photon is proportionate to the charge pulse height produced by the detector, thereby enabling energy measurement.

In various implementations, system 100 can be capable of providing output signals from first detector 114 and second detector 116 simultaneously in response to X-ray beam 118 interacting with substrate pair 112.

As noted, various other elements and components for X-ray measurement system 100 are omitted from FIG. 1 for descriptive clarity. For example, system 100 may operate in a vacuum environment, such as in a vacuum chamber in a semiconductor fabrication process. X-ray source 110 can include various means for filtering or directing X-ray beam 118 towards substrate pair 112. In particular implementations, X-ray beam 118 is generated using a copper (Cu) target, such as at around 8-9 keV energy, among other potential targets and energy bands in various implementations. When X-ray beam 118 is generated using the Cu target at around 8-9 keV, XRF can be performed through a Si substrate in substrate pair 112 having a thickness of about 50 nm to about 100 μm in order to avoid excessive self-absorption of X-rays, such as for D2D and D2 W bonding in a face-to-face or back-to-face arrangement, in which a first die to be bonded (e.g., first substrate 112-1) can receive incident X-ray beam 118 at a back surface or a face surface.

FIG. 2 is a depiction of an X-ray measurement system 200 (or simply system 200) using TL interferometry, in some implementations. As shown in FIG. 2, system 200 represents a partial configuration of dual X-ray measurement system 100 in FIG. 1 depicting three gratings used for TL interferometry. The TL interferometer setup generally comprises the three gratings shown in system 100, including a source modulation grating G0, a beam splitter grating G1, and an analyzer grating G2. In some implementations, source modulation grating G0 can be omitted when X-ray beam 118 has a long coherence length, such as when X-ray source 110 is a synchrotron. Source modulation grating G0, also known as an X-ray mask, can be placed close to the X-ray source. Source modulation grating G0 is designed to create an array of line sources by blocking parts of the X-ray beam, effectively producing partially coherent radiation from an incoherent source, like a conventional X-ray tube.

Beam splitter grating G1, also referred to as a phase grating G1, generates a periodic interference pattern that can have maximum intensity oscillations. Phase grating G1 is located downstream of source modulation grating G0, such as at a specific distance. The phase-shift caused by phase grating G1 leads to the creation of an interference pattern known as the Talbot carpet some distance away in the absence of a sample between gratings G0 and G1. Thus, a periodicity of the Talbot carpet can be a property of system 200 itself for any sample used.

The third component in system 200 is an analyzer grating G2, also referred to as an absorption grating G2, placed at one of the self-image planes of the Talbot carpet, which usually corresponds to a fractional Talbot distance. Analyzer grating G2 has periodic absorbing structures that can translate slight changes in interference fringes into intensity changes at first detector 114. The periodicity of the Talbot carpet in system 200 can be matched to a pitch of analyzer grating G2 to optimize sensitivity of displacement measurements of a sample, such as misalignment measurements of substrate pair 112. In some implementations, analyzer grating G2 can also be omitted, such as when first detector 114 has a spatial or pixel resolution that is substantially smaller than the interference fringes. Various types of X-ray detectors can be used as first detector 114. In particular, semiconductor X-ray detectors can be used for first detector 114, such as direct detection by a flat panel X-ray detector having good spatial resolution and X-ray absorbing properties, such as a semiconductor flat panel imaging array that can generate image data from received X-rays.

In system 200 shown in FIG. 2, analyzer grating G2 converts phase shifts into intensity variations (amplitude modulation), making the phase shifts detectable by first detector 114, for example. The pattern at the plane of first detector 114 carried by X-ray beam 120 can thus include information about the absorption, phase shift, and small-angle scattering caused by the sample (e.g., substrate pair 112, shown as first substrate 112-1 and second substrate 112-2 in FIG. 2). When the sample (substrate pair 112) is placed between phase grating G1 and analyzer grating G2, the X-ray interaction with the sample alters the interference pattern due to the modulation of the phase of incoming X-ray beam 118. The local changes in absorption, phase, and small-angle scattering lead to corresponding modifications in the intensity pattern in X-ray beam 120 that are measured by first detector 114 located behind analyzer grating G2. In practice, a series of images can be taken while laterally shifting one of phase grating G1/analyzer grating G2, such as across one or several periods. This step scanning process allows a reconstruction of differential phase contrast and dark-field images in addition to the standard transmission image.

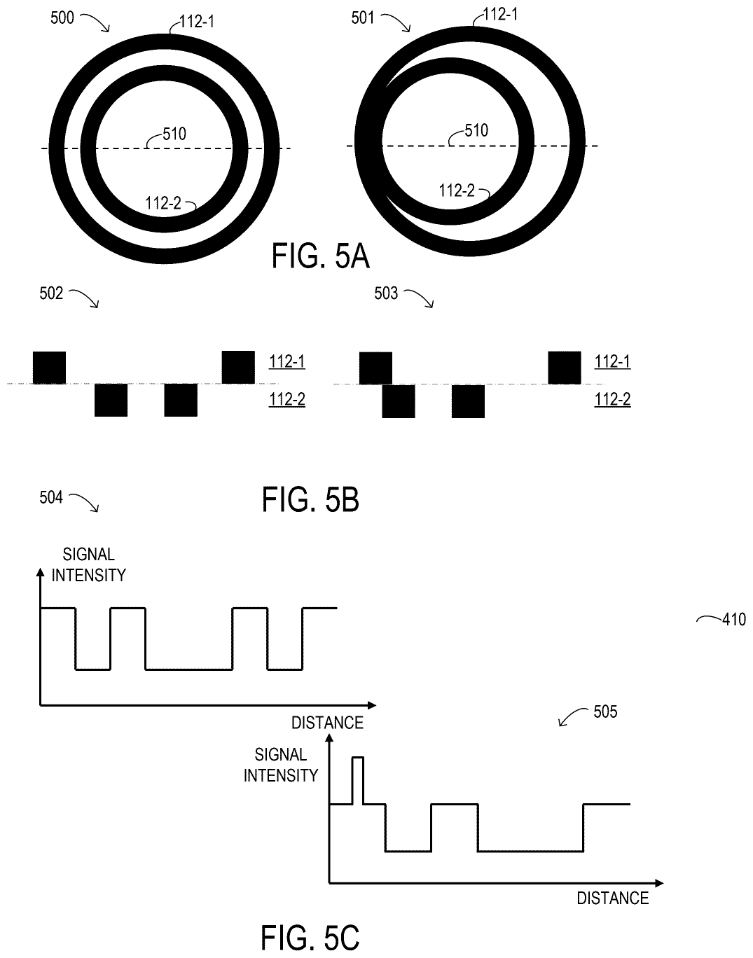

In operation, system 200 can employ TL interferometry and can analyze objects, such as substrate pair 112, in transmission. For example, first detector 114 can be used to detect transmission signals for alignment marks located on one or more surfaces of first substrate 112-1 and second substrate 112-2 (see also FIGS. 5A-C). Furthermore, when first substrate 112-1 and second substrate 112-2 also include interferometric alignment marks, such as Moiré interferometric patterns, that interact with X-ray beam 118, first detector 114 can be used to detect interferometric patterns associated with misalignment of the Moiré interferometric patterns. In particular implementations, a displacement of the Moiré interferometric patterns that first detector 114 can detect can be directly linear with the misalignment of first substrate 112-1 relative to second substrate 112-2, as will be described in further detail. The linear relationship can represent an effective magnification that system 200 can obtain from the Moiré interferometric patterns to increase sensitivity to the actual misalignment of substrate pair 112. The increased sensitivity to the actual misalignment can improve an accuracy of alignment of substrate pair 112 that can then be performed.

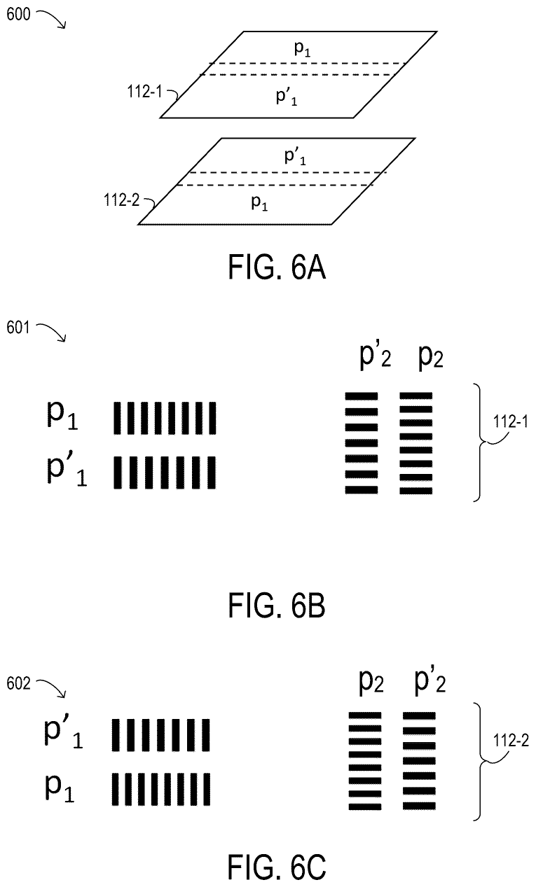

Furthermore, the Moiré interferometric patterns forming a Moiré interferometric grating pair can have a first grating orientation that can be aligned with a second grating orientation of beam splitter grating G1 and analyzer grating G2 to improve sensitivity or to achieve a maximum sensitivity for detecting a displacement of Moiré interferometric patterns relative to each other (e.g., detected misalignment). In order to detect and measure misalignment along different axes of substrate pair 112, substrate pair 112 can be rotated by a suitable angle that corresponds to grating orientations of different sets of Moiré interferometric grating pairs formed in first substrate 112-1 and second substrate 112-2, such as 45°, 90°, 135°, 180°, 225°, and 315° rotations in various implementations (see also FIGS. 6A-C, 8A-C and 9).

In particular implementations, X-ray beam 118 can have sufficient energy to penetrate thick Si substrates, including highly doped Si substrates, in order to perform TL interferometry using system 200. Accordingly, system 200 can be used to measure misalignment of substrate pair 112 using X-ray TL interferometry in various applications, such as for D2D, D2 W, and W2 W bonding. Furthermore, the ability of X-ray beam 118 to measure misalignment of substrate pair 112 when substrate pair 112 includes thick or highly doped Si substrates using TL interferometry, as shown in FIG. 2, can allow various relative semiconductor surface orientations of substrate pair 112 to be measured, including a face-to-face arrangement, a back-to-face arrangement, a face-to-back arrangement, and a back-to-back arrangement.

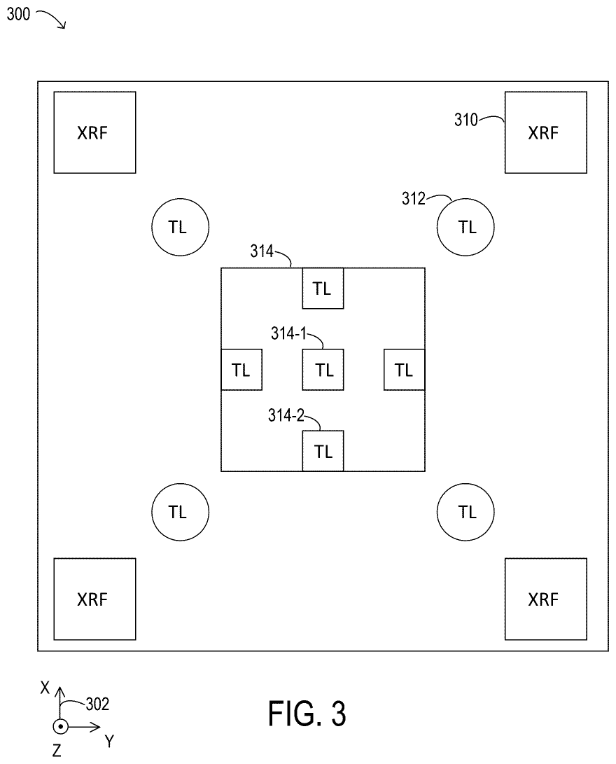

FIG. 3 is a depiction of composite alignment marks 300 for a semiconductor substrate, in some implementations. Composite alignment marks 300 include different individual alignment marks and are shown from a top view showing a general location and shape of the different alignment marks that will be described in further detail. In particular, composite alignment marks 300 can be judiciously formed on both the first substrate and the second substrate of substrate pair 112, correspondingly, to provide alignment using both TL interferometry methods and XRF methods, as disclosed herein. Also shown in FIG. 3 is coordinate legend 302 that shows a z axis emerging from the page, with x and y axes in the plane of the page, which is used for reference herein. In various implementations, a complementary set of alignment marks can be located at or near a top surface (e.g., a face) of the first substrate and at or near a top surface (e.g., a face) of the second substrate.

As shown and described in subsequent figures, various different alignment marks can be comprised of a metal for X-ray methods and systems for semiconductor substrate alignment disclosed herein. In particular implementations, the alignment marks disclosed herein can be made from copper (Cu) and can be formed at a particular location on a semiconductor substrate. In various implementations, the alignment marks can be made from another suitable material, such as another metal selected from nickel (Ni), tungsten (W), cobalt (Co), chromium (Cr), ruthenium (Ru), molybdenum (Mo), or various combinations or alloys thereof.

Furthermore, the alignment marks in composite alignment marks 300 can have various dimensions in the semiconductor substrate. For example, composite alignment marks 300 can have a thickness from about 100 nm to about 20 μm. In some implementations, the alignment marks can have a width from about 100 nm to about 20 μm. In cases where the alignment marks are periodic structures, such as the Moiré-fringe alignment marks, the alignment marks can have a pitch from about 200 nm to about 40 μm. In particular implementations, the alignment marks in composite alignment marks 300 can be formed in prior process steps of semiconductor fabrication, such as by deposition and lithography, among other processes.

As shown in FIG. 3, composite alignment marks 300 can accordingly represent an area on a semiconductor substrate that can be used for X-ray methods and systems for semiconductor substrate alignment, as disclosed herein. Because composite alignment marks 300 include different types of alignment marks that can be used for different types of alignment techniques, as will be described in further detail, the different alignment techniques can be performed without having to move the substrate or to adjust the X-ray system (e.g., a single FOV), which is desirable. In other words, composite alignment marks 300 can provide the ability to quickly and accurately determine misalignment of substrate pair 112 using different techniques over a wide range of misalignment ranges and with different accuracy. For example, composite alignment marks 300 can be used for coarse alignment (lower spatial resolution) and then fine alignment (higher spatial resolution) using the same equipment and configuration, within the same FOV for the incident X-rays, which is desirable. Furthermore, multiple or redundant alignment marks can be included in composite alignment marks 300 for improved accuracy, precision, and overall reliability, such as by increasing a sample size of measured alignment marks, or when certain individual alignment marks are defective or are not operational among other alignment marks that are operational, in particular implementations.

As shown in FIG. 3, composite alignment marks 300 are an exemplary layout of individual alignment marks that can be rearranged or reconfigured in different implementations. As shown, composite alignment marks 300 include XRF marks 310 that can be square and can be located at corners of composite alignment marks 300. XRF marks 310 can be located at a substrate top surface (e.g., a face) or can be covered by a silicon (Si) top layer that ranges in thickness from about 50 nm to 100 μm, that can still provide an adequate amount of fluorescent X-ray photons without excessive self-absorption by the silicon (Si) top layer. In various implementations, XRF marks 310 can be used for D2D or D2 W bonding, as described above, to measure a first coarse misalignment, and subsequently to perform a first coarse alignment of first substrate 112-1 to second substrate 112-2. The first coarse alignment of first substrate 112-1 to second substrate 112-2 using XRF marks 310 can allow subsequent coarse or fine alignments with other ones of composite alignment marks 300, such as by reducing the misalignment to a lower value that permits further measurements of the remaining fine misalignment, as described below.

Composite alignment marks 300, as shown, also include first TL marks 312 that can be used with TL interferometry, such as by using X-ray measurement system 200 (see FIG. 2) to measure a second coarse misalignment. In particular implementations, the second coarse misalignment can be smaller than the first coarse misalignment performed using XRF marks 310. Composite alignment marks 300, as shown, also include second TL marks 314 that can be square areas that include Moiré grating elements for Moiré fringe-based interferometry alignment. In particular implementations as will be described below, first substrate 112-1 and second substrate 112-2 may each include composite alignment marks 300 having second TL marks 314 that include one of two complementary Moiré patterns that together form a Moiré interferometric grating pair when placed adjacent to each other, or in proximity to each other, such as in substrate pair 112. Furthermore, while XRF marks 310 and first TL marks 312 can be used with X-ray beam 118 in different orientations, Moiré patterns located in second TL marks 314 can be advantageously aligned to beam splitter grating G1, such that the respective grating axes are parallel to each other for improved signal-to-noise ratio and improved sensitivity. As will be described below, second TL marks 314 can be used for a first fine alignment and a second fine alignment that can have overlapping measurement ranges and different levels of magnification, and so, can provide a wide detection range for misalignment distance or displacement.

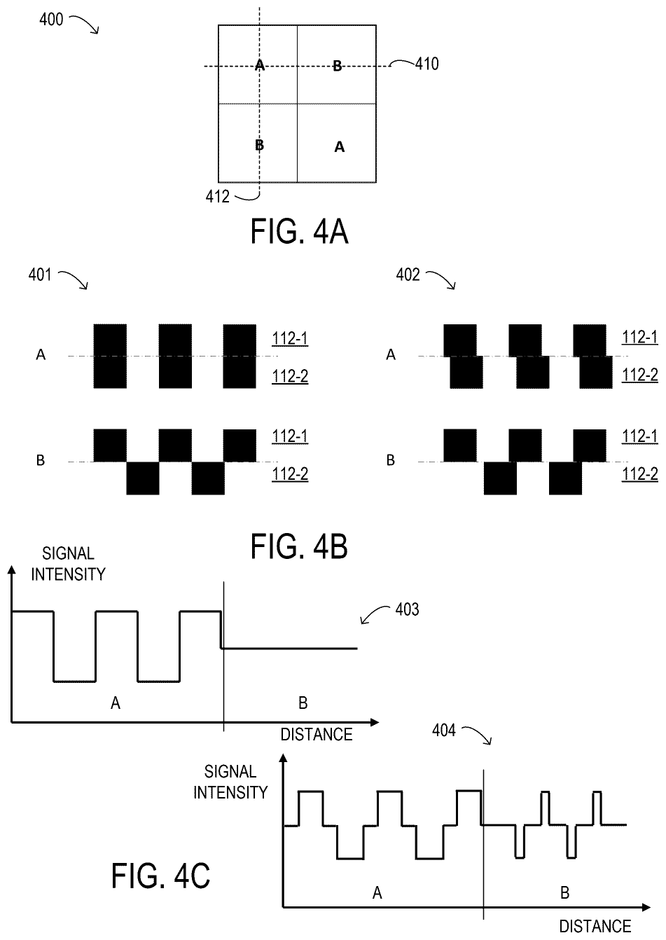

FIGS. 4A, 4B, and 4C depict an XRF misalignment detection process, in some implementations. FIG. 4A is a depiction of an XRF alignment mark 400 that can represent an instance of XRF mark 310 shown in FIG. 3. With XRF alignment mark 400 is shown a sampling line 410 that can indicate where XRF measurements of fluorescent X-rays are made to detect alignment marks 401 and 402 shown in FIG. 4B, to result in corresponding measurement signals shown in FIG. 4C. In order to obtain line profile XRF measurements along sampling line 410, substrate pair 112 can be moved along the Y-axis relative to X-ray beam 118 while XRF measurements are recorded. The XRF measurements can be recorded using an SDD that is configured as a point detector. In XRF alignment mark 400, fields A and B are shown that are described below with respect to FIG. 4B. Furthermore, when substrate pair 112 is to be aligned along two axes, such as along the Y-axis and along the X-axis, a sampling line 412 can be used along the X-axis, while the alignment marks along sampling line 412 can be oriented for X-axis alignment.

FIG. 4B depicts alignment marks 401 and 402 that represent metal pads, such as copper (Cu) pads, that form XRF alignment marks 400 for a first substrate 112-1 and a second substrate 112-2 that form substrate pair 112. A dashed line between the metal pads indicates a surface interface between first substrate 112-1 and second substrate 112-2. In alignment marks 401, three metal pads are at the same locations in first substrate 112-1 and second substrate 112-2 for field A and are shown in an aligned state. In alignment marks 401, for field B, first substrate 112-1 is shown having the same alignment marks as for field A, while second substrate 112-2 has two alignment marks that are offset from the alignment marks in substrate 112-1, but also depict an aligned state. In alignment marks 402, the same metal pads as shown in alignment marks 401 are depicted, but are shown with a slight misalignment, for both fields A and B.

FIG. 4C depicts plots 403 and 404 of XRF signal intensity versus distance along sampling line 410. The XRF signal intensity on the Y-axis of plots 403 and 404 can correspond to an intensity of fluorescent X-rays detected from emission of the metal pads shown in FIG. 4B upon illumination by X-ray beam 118. Each point in plots 403 and 404 thus corresponds to a point along sampling line 410 with a left portion of the plot corresponding to field A and a right portion of the plot corresponding to field B, as indicated.

Plot 403 in FIG. 4C shows XRF signal intensity for alignment marks 401 that are in the aligned state. In plot 403, the signal intensity is about double in amplitude corresponding to alignment marks 401 for field A that are located at the same position in first substrate 112-1 and second substrate 112-2, resulting in about twice the fluorescent photon intensity. In plot 403, for field B, a constant amplitude corresponding to a single alignment mark corresponds to the offset alignment marks in first substrate 112-1 and second substrate 112-2.

Plot 404 in FIG. 4C shows XRF signal intensity for alignment marks 402 that are slightly misaligned. In plot 404, at the left portion, dual stepped peaks of XRF signal intensity at double amplitude correspond to a reduced distance along sampling line 410 where alignment marks 402 in field A overlap, while the signal portions at single amplitude correspond to the small shoulders where alignment marks 402 in field A do not overlap in first substrate 112-1 and second substrate 112-2. In plot 404, at the right portion corresponding to field B alignment marks 402, double amplitudes correspond to alignment marks 402 in first substrate 112-1 and second substrate 112-2 overlapping, while single amplitudes correspond to one alignment mark being measured in either first substrate 112-1 or second substrate 112-2. Also, a zero signal (shown as a minimum value in plot 404) corresponds to no alignment mark being measured from either first substrate 112-1 or second substrate 112-2, at a corresponding distance where a gap in alignment marks 402 for field B are present.

In operation, when alignment marks 402 are observed based on signal patterns in plot 404, a misalignment of first substrate 112-1 and second substrate 112-2 can be detected, also referred to as a detected misalignment. A library of plots similar to 403 or 404 could be created to record different alignment positions, and used to estimate the detected misalignment. To perform alignment, a lateral position of the substrates in substrate pair 112, such as along line 410 can be adjusted until the signal patterns in plot 403 are observed, indicating alignment marks 401 that are in an aligned condition and that first substrate 112-1 is aligned to second substrate 112-2.

FIGS. 5A, 5B, and 5C depict an X-ray transmission misalignment detection process, in some implementations. FIG. 5A includes a depiction of TL alignment mark 500 that can represent an aligned state of first TL mark 312 shown in FIG. 3. FIG. 5A also includes a depiction of TL alignment mark 501 that can represent a misaligned state of first TL mark 312 shown in FIG. 3. Each of alignment marks 500 and 501 are in the form of a circular ring in which an outer ring is located in first substrate 112-1 and an inner ring is located in second substrate 112-2 (see also FIG. 5B). With TL alignment marks 500 and 501 is shown a sampling line 510 that can indicate where TL transmission measurements are made through substrate pair 112 to detect alignment marks 502 and 503 shown in FIG. 5B, to result in corresponding measurement signals shown in FIG. 5C. In order to obtain line profile TL transmission measurements along sampling line 510, substrate pair 112 can be moved along the Y-axis relative to X-ray beam 118 while TL transmission measurements are recorded, such as by using X-ray measurement system 200 in FIG. 2. In some implementations, the TL transmission measurements can be recorded from an image captured by first detector 114. The TL transmission measurements along sampling line 510 can also be obtained by moving analyzer grating G2 with respect to first detector 114 for interferometric lateral sampling.

FIG. 5B depicts alignment marks 502 and 503 that represent cross-sections of the circular alignment marks 500 and 501, respectively intersecting sampling line 510 in FIG. 5A. Alignment marks 502 and 503 are depicted as metal pads, such as copper (Cu) pads, that form TL alignment marks 500 and 501, respectively, for a first substrate 112-1 and a second substrate 112-2 that form substrate pair 112. A dashed line between the metal pads in FIG. 5B indicates a surface interface between first substrate 112-1 and second substrate 112-2. In alignment marks 502 and 503, two metal pads are shown above and below the surface interface corresponding to cross-sections of the outer ring and the inner ring in FIG. 5A.

Plot 504 in FIG. 5C shows TL signal intensity for alignment marks 502 that are in the aligned state. In plot 504, the signal intensity shows a single amplitude corresponding to alignment marks 502 for aligned inner and outer rings in FIG. 5A. In plot 504, the alignment marks in first substrate 112-1 and second substrate 112-2 do not overlap, resulting in a uniform fluorescent X-ray photon maximum intensity, and showing gaps in between alignment marks 502 that are uniformly spaced, corresponding to minimum signal intensity.

Plot 505 in FIG. 5C shows TL signal intensity for alignment marks 503 that are slightly misaligned. In plot 505, the signal intensity shows single and double amplitude corresponding to alignment marks 503 for misaligned inner and outer rings in FIG. 5A. In plot 505, alignment marks 503 in first substrate 112-1 and second substrate 112-2 do overlap slightly, resulting in double TL signal intensity at that distance along sampling line 510. Plot 505 also shows gaps in between alignment marks 503 that are not uniformly spaced, corresponding to minimum intensity.

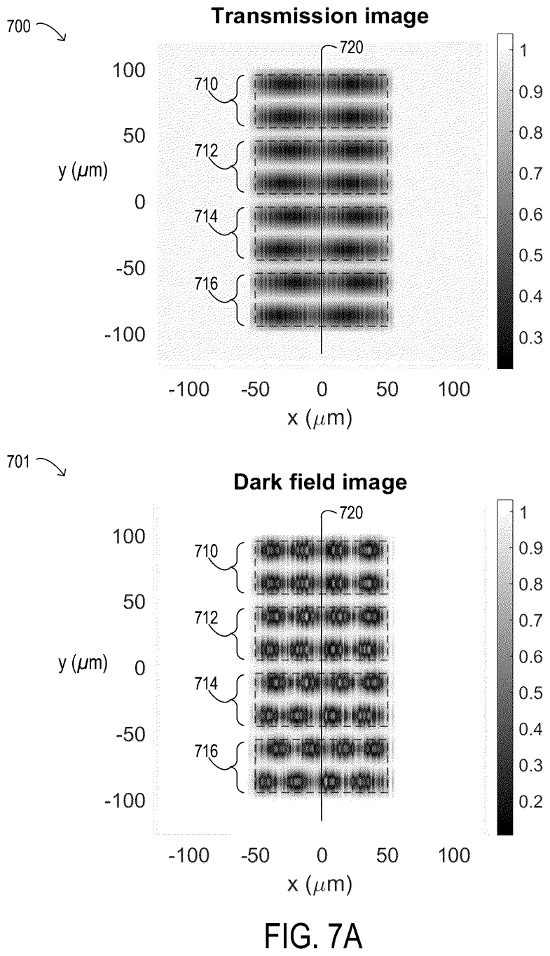

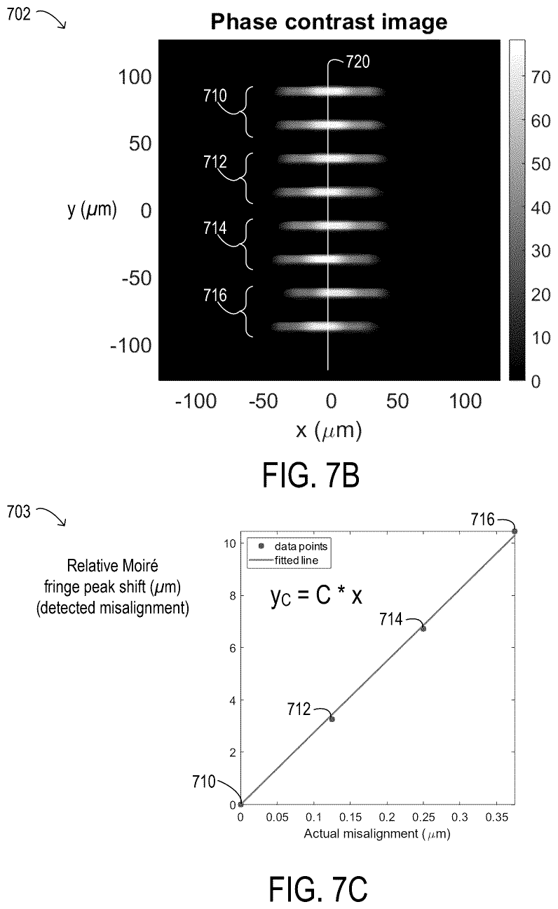

In operation, when alignment marks 501 and 503 are observed based on the signal pattern in plot 505, the misalignment of the first substrate with respect to the second substrate can be detected, also referred to as a detected misalignment. A library of reference plots similar to plots 504 or 505 could be created to record different alignment positions, and used to estimate the detected misalignment. The stored library of reference plots can be indexed to calibrated misalignment values to match observed signal intensity plots 504 or 505 to a detected misalignment of alignment marks 502 or 503 for example. In various implementations, different methods can be used to generate plots 504 or 505. In one implementation, one of phase grating G1 or analyzer grating G2 can be moved to detect signal intensity from X-rays received at first detector 114, such as when first detector 114 is an SDD or other small area X-ray detector (e.g., a beam detector). The moving of phase grating G1 or analyzer grating G2 can effectively result in a line scan that generates signal intensity plots 504 or 505 that can be captured by the SDD and recorded. In another implementation, when first detector 114 is a flat panel X-ray detector that outputs image data, plots 504 or 505 can be discerned or generated from the image data. In particular implementations, instead of storing a reference library of plots 504 or 505, a stored library of reference image data can be used to match observed image data to a detected misalignment of alignment marks 502 or 503. It is noted that reference image data can also be used with alignment marks 600 and 800 that comprise Moiré fringe elements, as described in further detail below, to match observed image data to a detected misalignment of Moiré interferometric patterns (see FIGS. 7A and 7B). To perform alignment, a lateral position of the substrates in substrate pair 112 can be adjusted until the signal patterns in plot 504 are observed, indicating alignment marks 500 and 502 that are in an aligned condition and that first substrate 112-1 is aligned to second substrate 112-2.

FIGS. 6A, 6B, and 6C, depict Moiré-fringe alignment marks for a semiconductor substrate, in some implementations. FIG. 6A depicts alignment marks 600 that can be an instance of second TL marks 314 in FIG. 3. Specifically, alignment marks 600 are shown in a square field divided into two rectangles that correspond to locations of complementary Moiré grating elements p₁ and p′₁ as shown in FIGS. 6B and 6C. In alignment marks 600, two layers of complementary Moiré grating elements p₁ and p′₁ are shown corresponding to first substrate 112-1 and second substrate 112-2 in substrate pair 112, which when placed together in proximity form a Moiré interferometric grating pair. When first substrate 112-1 and second substrate 112-2 are in proximity to each other, such as in substrate pair 112, each Moiré grating element (e.g., a single row p₁ or p′₁) is paired with a complementary Moiré grating element (e.g., a single row p′₁ or p₁) to form a Moiré interferometric grating by superposition. Since each layer corresponding to first substrate 112-1 and second substrate 112-2 has two Moiré grating elements, alignment marks 600 form a Moiré interferometric grating pair.

In FIG. 6B, a pair of single row Moiré grating elements 601 corresponding to first substrate 112-1 are shown at left oriented along the X-axis and at right oriented along the Y-axis. In FIG. 6C, a pair of single row Moiré grating elements 602 corresponding to second substrate 112-2 are shown at left oriented along the X-axis and at right oriented along the Y-axis. Each single row Moiré grating element 601 in first substrate 112-1 is paired with a complementary single row Moiré grating element 602 in second substrate 112-1 to form a Moiré interferometric grating. For the dual row Moiré grating elements 601, elements having a pitch p₁ and p′₁ are paired together, such that the two rows form the Moiré interferometric grating pair. The pitch relationship is given by Equation 1, in which Δp is a difference in pitch.

$${p}_{1}^{′} = {p}_{1} + Δ p \qquad Equation 1$$

Then, the resulting Moiré interferometric grating can be defined by a Moiré period given in Equation 2 and a Moiré magnification given in Equation 3 below.

$$Moiré period = \frac{{p}_{1} {p}_{1}^{′}}{Δ p} \qquad Equation 2$$

$$Moiré magnification = \frac{{p}_{1} + {p}_{1}^{′}}{Δ p} \qquad Equation 3$$

From the Moiré patterns generated corresponding to the Moiré interferometric gratings in the pair, a misalignment direction is orthogonal to the orientation of the Moiré interferometric grating, while each complementary Moiré interferometric grating (e.g., reversed in the grating pairs) results in a misalignment shift in the Moiré pattern in an opposite direction (see also FIGS. 7A and 7B). Although the Moiré grating elements 601 and 602 are shown rotated 90° corresponding to the X-axis and the Y-axis, in different implementations, different orientations can be used, such as 45° or 135°. The Moiré interferometric grating elements oriented along the X-axis in FIGS. 6B and 6C are labeled p₁ and p′₁, while the Moiré interferometric grating elements oriented along along the Y-axis are labeled p₂ and p′₂.

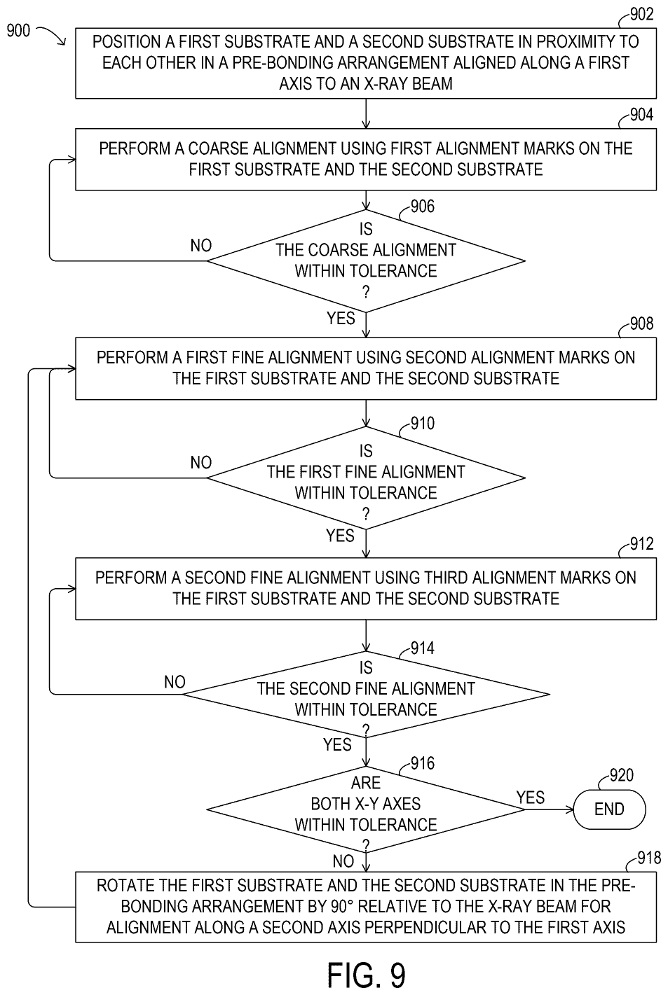

In particular implementations, alignment marks 600 in the form of the Moiré interferometric grating pair can be used with X-ray measurement system 200 in the TL transmission arrangement with substrate pair 112 (see FIG. 2). Because the measurement sensitivity is greatest when the Moiré interferometric grating pair orientation aligns with an orientation of beam splitter grating G1 and/or analyzer grating G2, the orthogonal gratings shown in FIGS. 6B and 6C can be used by rotating substrate pair 112 relative to X-ray beam 118 by 90° in system 200, in various implementations. In this manner, substrate pair 112 can be aligned along both the X-axis and the Y-axis using system 200, for example (see also FIG. 9).

FIGS. 7A and 7B, depict Moiré-fringe X-ray transmission alignment images, in some implementations. In FIG. 7A, Moiré-fringe X-ray transmission alignment image show a pair of interferometric patterns corresponding to the Moiré interferometric grating pairs, such as shown with respect to FIGS. 6A-C above. Specifically, in FIG. 7A, transmission images 700 and dark field images 701 are shown, while in FIG. 7B phase contrast images 702 are shown.

Transmission images 700, dark field images 701, and phase contrast images 702 can be captured using first detector 114 with X-ray measurement system 200 in FIG. 2, in which X-ray beam 118 irradiates Moiré interferometric grating pairs formed in substrate pair 112. In each of transmission images 700, dark field images 701, and phase contrast images 702, a pair of Moiré interferometric patterns (corresponding to a Moiré interferometric grating pair) are shown for four (4) reference misalignment values of first substrate 112-1 relative to second substrate 112-2: Moiré interferometric patterns 710 show zero (0) misalignment or aligned; Moiré interferometric patterns 712 show 125 nm of misalignment; Moiré interferometric patterns 714 show 250 nm of misalignment; and Moiré interferometric patterns 716 show 375 nm of misalignment. As noted, each Moiré interferometric pattern in a pair (resulting from the complementary Moiré interferometric grating pair) results in translation in an opposite direction from a centerline 720. The respective translation in the pairs of interferometric patterns (e.g., the detected misalignment) can be seen increasing as the actual misalignment of substrate pair 112 increases, which can be recorded and analyzed, such as by using digital image processing, to determine the actual misalignment. In particular, a displacement of each interferometric pattern from centerline 720 can be well discerned by the human eye in phase contrast images 702 in FIG. 7B. In operation, actual misalignment can be determined using any or all of transmission images 700, dark field images 701, and phase contrast images 702, such as depending on the material properties of the Moiré interferometric grating pair used, among other factors and variables.

In operation, when Moiré interferometric patterns 716 are observed, the misalignment of first substrate 112-1 with respect to second substrate 112-2 (e.g., of substrate pair 112) can be detected, also referred to as a detected misalignment. In various implementations, the actual misalignment of substrate pair 112 is measured by using a linear relationship to calculate the actual misalignment from the detected misalignment (see also FIG. 7C). To perform alignment, a lateral position of the substrates in substrate pair 112 can be displaced relative to each other until Moiré images 710 are observed, indicating that first substrate 112-1 is aligned to second substrate 112-2.

FIG. 7C is a calibration plot 703 for Moiré interferometric patterns, in some implementations. In calibration plot 703, a positive linear relationship between a Moiré interferometric pattern displacement, representing a detected misalignment, and an actual misalignment of first substrate 112-1 with respect to second substrate 112-2 is determined using linear regression for misalignment values corresponding to Moiré images 710, 712, 714, and 716. The detected misalignment from the Moiré interferometric pattern displacement is given as a sum of the misalignment of both patterns in a pair. Calibration plot 703 shows that the detected misalignment magnifies the actual misalignment with a magnification factor C given by a slope value of about 27, which indicates that Moiré-fringe TL X-ray transmission measurements, as described herein, provide increased sensitivity for measuring the actual misalignment of substrate pair 112, which is desirable.

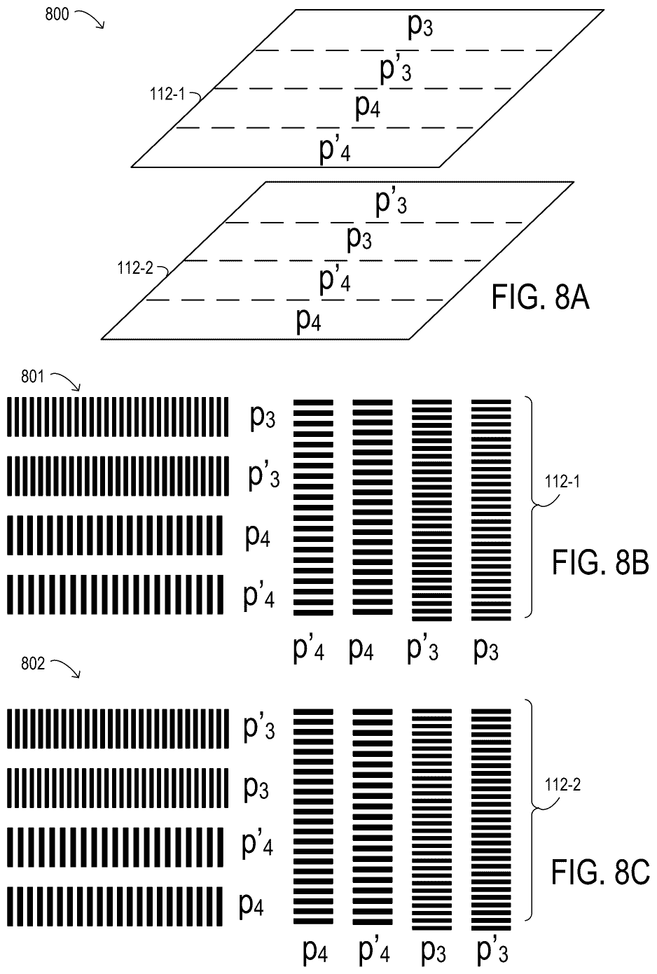

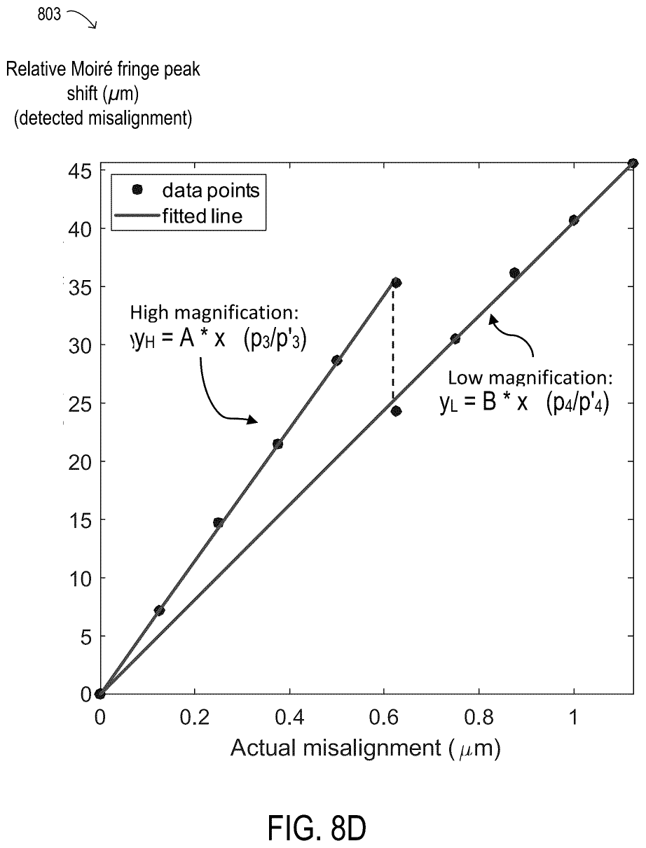

FIGS. 8A, 8B and 8C depict Moiré-fringe alignment marks for a semiconductor substrate, in some implementations. FIG. 8A depicts alignment marks 800 that can be an instance of second TL marks 314 in FIG. 3. Specifically, alignment marks 800 are shown in a square field divided into four rectangles that correspond to locations of two Moiré interferometric grating pairs. The Moiré grating elements in alignment marks 800 are labeled as p₃ and p′₃, for high magnification, and as p₄ and p′₄, for low magnification, as shown in FIGS. 8B and 8C. In alignment marks 800, two layers of two rows of complementary Moiré grating elements are shown corresponding to first substrate 112-1 and second substrate 112-2 in substrate pair 112, which together form two Moiré interferometric grating pairs, one for high magnification (p₃/p′₃) and one for low magnification (p₄/p′₄). When first substrate 112-1 and second substrate 112-2 are in proximity to each other, such as in substrate pair 112, two Moiré grating elements (e.g., two rows of marks) are paired with complementary two Moiré grating elements to form one Moiré interferometric grating pair by superposition. The two Moiré grating elements comprising the two rows of complementary marks can be collectively referred to as one alignment mark for each of first substrate 112-1 and second substrate 112-2 that together form one Moiré interferometric grating pair.

In particular implementations, each field or Moiré grating element in alignment marks 800 may be concurrently irradiated by an incident X-ray beam, such as X-ray beam 118 in system 200, such that an overall size of alignment marks 800 may be smaller than or similar to a cross-sectional area of the incident X-ray beam. In this manner, various misalignment measurements described below can be performed without readjustment or reconfiguration of the X-ray beam, in some implementations, which is desirable.

In FIG. 8B, two pairs of single row Moiré grating elements 801 corresponding to first substrate 112-1 are shown at left oriented along the X-axis and at right oriented along the Y-axis. In FIG. 8C, two pairs of single row Moiré grating elements 802 corresponding to second substrate 112-2 are shown at left oriented along the X-axis and at right oriented along the Y-axis. Each Moiré grating element 801 in first substrate 112-1 is paired with a complementary Moiré grating element 802 in second substrate 112-1. For the Moiré interferometric grating pairs formed using Moiré grating elements 801 and 802, grating elements having a pitch p₃ and p′₁ are paired together for high magnification, while grating elements having a pitch p₄ and p₄ are paired together for low magnification, such that the pitch relationship is given by Equation 1.

FIG. 8D is a calibration plot 803 for Moiré interferometric patterns, in some implementations. Calibration plot 803 is similar to calibration plot 703 in FIG. 7C, showing actual misalignment of first substrate 112-1 with respect to second substrate 112-2 in substrate pair 112, based on a detected misalignment from alignment marks 800. Calibration plot 803 shows two different linear curves corresponding to Moiré interferometric grating pairs formed by alignment marks 800, as noted above. The slope of the curve for high magnification is given by A (e.g., for p₃ and p′₃), while the slope of the curve for low magnification is given by B (e.g., for p₄ and p′₄). As shown in calibration plot 803, the magnification factor A is about 57, while the magnification factor B is about 41, such that B<A. In various implementations, Moiré interferometric grating pairs can be formed on various substrates, for particular orientations and configurations, that can be used to achieve magnification factors of up to 100 or more in this manner.

More generally, for each Moiré interferometric grating pair having respective grating element pitches pₙ and p′ₙ, a lower limit of detection (LOD) is given by Equation 4, and an upper LOD is given by Equation 5.

$$LOD lower = \frac{Talbot fringe period}{Moiré magnification factor} \qquad Equation 4$$

$$LOD upper = \frac{{p}_{n} {p}_{n}^{′}}{2 ( {p}_{n} + {p}_{n}^{′} )} \qquad Equation 5$$

In Equation 4, the Talbot fringe period corresponds to a pitch of analyzer grating G2 that can match the periodicity of the Talbot carpet for the TL measurement system, such as system 200. The Moiré interferometric grating pair for high magnification is used to minimize the lower LOD, while the Moiré interferometric grating pair for low magnification is used to maximize the upper LOD. Furthermore, the lower LOD for low magnification is smaller than the upper LOD for high magnification to provide continuous coverage of actual misalignment without gaps. A total misalignment range that can be measured using alignment marks 800 can thus extend from the lower LOD for high magnification to the upper LOD for low magnification and can be detected and measured in a single FOV using system 200, which is desirable.

FIG. 9 is a flowchart depicting a method 900 of aligning two semiconductor substrates using X-ray alignment methods and systems, in some implementations. It is noted that certain operations in method 900 may be rearranged or omitted in various embodiments. Method 900 can be performed using X-ray measurement system 100 and/or 200, in particular implementations.

Method 900 may begin at step 902 by positioning a first substrate and a second substrate in proximity to each other in a pre-bonding arrangement aligned along a first axis to an X-ray beam. The pre-bonding arrangement can involve positioning the first substrate and the second substrate in proximity to each other, such as in substrate pair 112. At step 904, a coarse alignment is performed using first alignment marks on the first substrate and the second substrate. In some implementations, the coarse alignment in step 904 can include measuring a first coarse misalignment using XRF, for example for D2D or D2 W bonds, such that the first alignment marks include XRF marks 310. The coarse alignment in step 904 can further include measuring a second coarse misalignment by a TL method such that the first alignment marks may comprise first TL marks 312. At step 906 a decision is made whether the coarse alignment is within tolerance. When the result of step 906 is NO, method 900 loops back to step 904. When the result of step 906 is YES, at step 908, a first fine alignment is performed using second alignment marks on the first substrate and the second substrate. The second alignment marks in step 908 can be second TL marks 314 that represent alignment marks 800 (see FIGS. 3, 8A-C) such that the first fine alignment is performed with low magnification (e.g., using p₄ and p₄).

In method 900, at step 910 a decision is made whether the first fine alignment is within tolerance. When the result of step 910 is NO, method 900 loops back to step 908. When the result of step 910 is YES, at step 912, a second fine alignment is performed using third alignment marks on the first substrate and the second substrate. The third alignment marks in step 912 can be second TL marks 314 that represent alignment marks 800 (see FIGS. 3, 8A-C) such that the second fine alignment is performed with high magnification (e.g., using p₃ and p′₃). In particular implementations, steps 908 and 912 can be performed using the same irradiating X-ray beam using system 200 corresponding to the same FOV of system 200. At step 914 a decision is made whether the second fine alignment is within tolerance. When the result of step 914 is NO, method 900 loops back to step 912. When the result of step 914 is YES, at step 916, a decision is made whether both X-Y axes are within tolerance. Both X-Y axes in step 916 refers to the X-axis and the Y-axis in plane with the first substrate and the second substrate. When the result of step 916 is YES, method 900 ends at step 920. When the result of step 916 is NO, at step 918, the first substrate and the second substrate are rotated in the pre-bonding arrangement by 90° relative to the X-ray beam for alignment along a second axis perpendicular to the first axis. After step 918, method 900 loops back to step 908

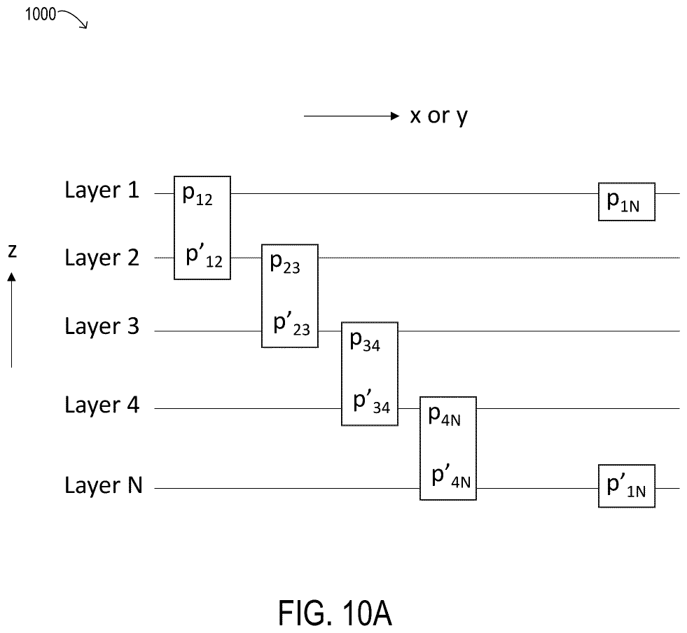

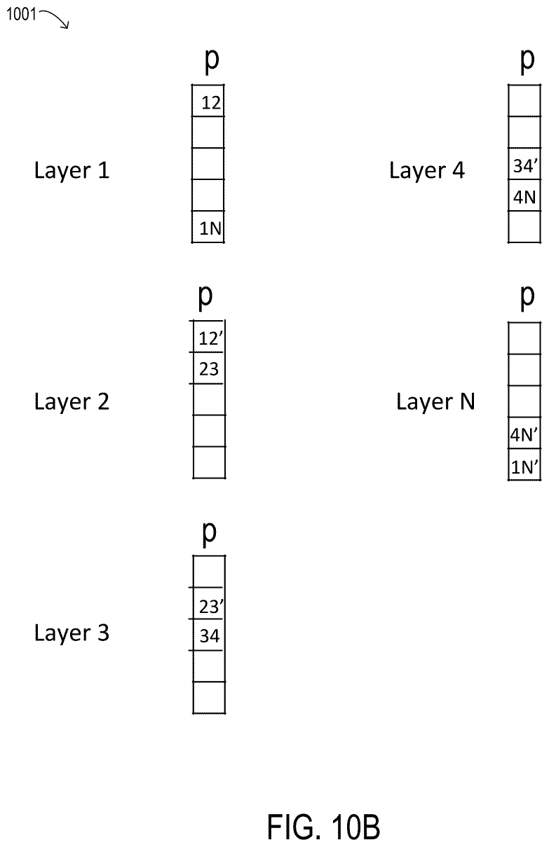

FIGS. 10A and 10B are depictions of multi-layer Moiré-fringe alignment marks, in some implementations. The alignment marks, indicating locations of Moiré interferometric grating pairs, represented in FIGS. 10A and 10B can correspond to alignment marks 600 or 800, as described above. FIG. 10A shows a side view 1000 of multiple layers along the Z-axis up to an arbitrary number of layers N. For each pair of adjacent layers, Moiré interferometric grating pairs can be placed at different locations in a spatially separated manner to provide alignment between the respective two layers indicated in FIG. 10A. The multiple layers can represent multiple semiconductor substrates for multi-layer 3D integration and bonding. Alignment marks for layer N relative to layer 1 are also provided. FIG. 10B shows layout arrangements 1001 for each alignment pair shown in a top view, in one implementation, showing an arrangement of corresponding Moiré interferometric grating pairs from side view 1000 in the X-Y plane in an arbitrary orientation.

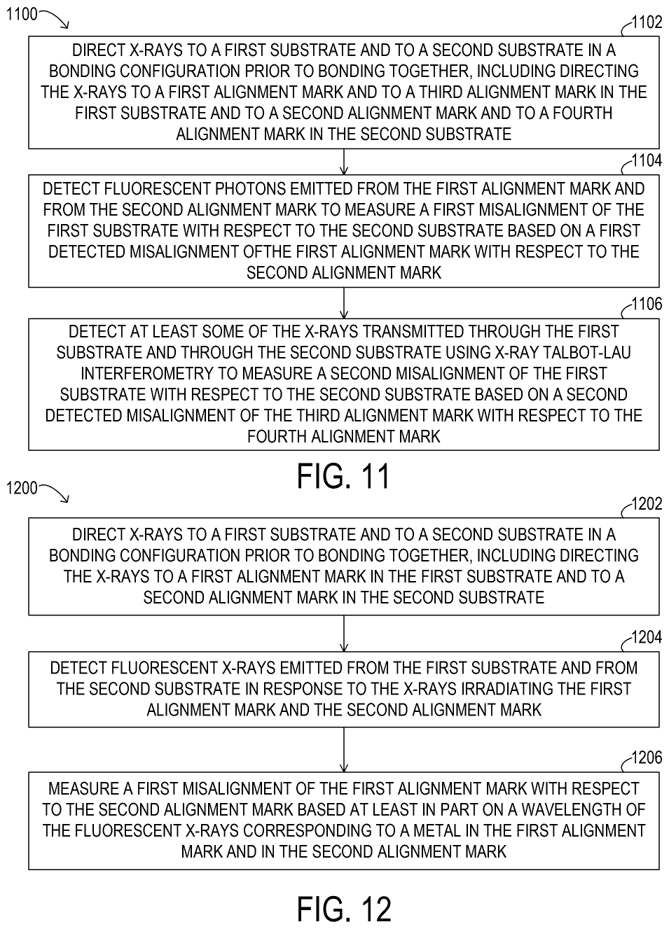

FIG. 11 is a flowchart depicting a method 1100 of aligning two semiconductor substrates using X-ray alignment methods and systems, in some implementations. It is noted that certain operations in method 1100 may be rearranged or omitted in various embodiments. Method 1100 can be performed using X-ray measurement system 100 and/or 200, in particular implementations.

Method 1100 may begin at step 1102 by directing X-rays to a first substrate and to a second substrate in a bonding configuration prior to bonding together, including directing the X-rays to a first alignment mark and to a third alignment mark in the first substrate and to a second alignment mark and to a fourth alignment mark in the second substrate. At step 1104, fluorescent X-rays emitted from the first alignment mark and from the second alignment mark are detected to measure a first misalignment of the first substrate with respect to the second substrate based on a first detected misalignment of the first alignment mark with respect to the second alignment mark. At step 1106, at least some of the X-rays transmitted through the first substrate and through the second substrate are detected using X-ray Talbot-Lau interferometry to measure a second misalignment of the first substrate with respect to the second substrate based on a second detected misalignment of the third alignment mark with respect to the fourth alignment mark.

FIG. 12 is a flowchart depicting a method 1200 of aligning two semiconductor substrates using X-ray alignment methods and systems, in some implementations. It is noted that certain operations in method 1200 may be rearranged or omitted in various embodiments. Method 1200 can be performed using X-ray measurement system 100 and/or 200, in particular implementations.

Method 1200 may begin at step 1202 by directing X-rays to a first substrate and to a second substrate in a bonding configuration prior to bonding together, including directing the X-rays to a first alignment mark in the first substrate and to a second alignment mark in the second substrate. At step 1204, fluorescent X-rays emitted from the first substrate and from the second substrate are detected in response to the X-rays irradiating the first alignment mark and the second alignment mark. At step 1206, a first misalignment of the first alignment mark with respect to the second alignment mark is measured based at least in part on a wavelength of the fluorescent X-rays corresponding to a metal in the first alignment mark and in the second alignment mark.

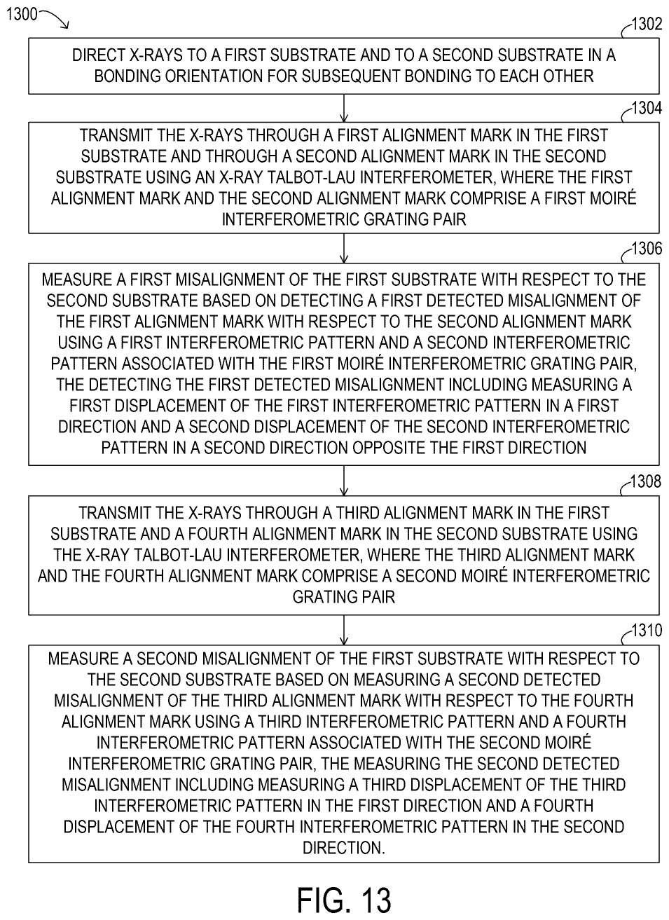

FIG. 13 is a flowchart depicting a method 1300 of aligning two semiconductor substrates using X-ray alignment methods and systems, in some implementations. It is noted that certain operations in method 1300 may be rearranged or omitted in various embodiments. Method 1300 can be performed using X-ray measurement system 100 and/or 200, in particular implementations.

Method 1300 may begin at step 1302 by directing X-rays to a first substrate and to a second substrate in a bonding orientation for subsequent bonding to each other. At step 1304, the X-rays are transmitted through a first alignment mark in the first substrate and through a second alignment mark in the second substrate using an X-ray Talbot-Lau interferometer, where the first alignment mark and the second alignment mark comprise a first Moiré interferometric grating pair. At step 1306, a first misalignment of the first substrate with respect to the second substrate is measured based on detecting a first detected misalignment of the first alignment mark with respect to the second alignment mark using a first interferometric pattern and a second interferometric pattern associated with the first Moiré interferometric grating pair, the detecting the first detected misalignment including measuring a first displacement of the first interferometric pattern in a first direction and a second displacement of the second interferometric pattern in a second direction opposite the first direction.

At step 1308, the X-rays are transmitted through a third alignment mark in the first substrate and a fourth alignment mark in the second substrate using the X-ray Talbot-Lau interferometer, where the third alignment mark AND the fourth alignment mark comprise a second Moiré interferometric grating pair. At step 1310, a second misalignment of the first substrate with respect to the second substrate is measured based on measuring a second detected misalignment of the third alignment mark with respect to the fourth alignment mark using a third interferometric pattern and a fourth interferometric pattern associated with the second Moiré interferometric grating pair, the measuring the second detected misalignment including measuring a third displacement of the third interferometric pattern in the first direction and a fourth displacement of the fourth interferometric pattern in the second direction.

As disclosed herein in one implementation, X-rays are directed to a first substrate and to a second substrate in a bonding configuration for bonding together. The X-rays are directed to first and third alignment marks in the first substrate and to second and fourth alignment marks in the second substrate. Fluorescent X-rays are detected upon emission from the first alignment mark and the second alignment mark to measure a first misalignment of the first substrate with respect to the second substrate based on a first detected misalignment of the first and second alignment marks. X-rays transmitted through the first and second substrates using X-ray Talbot-Lau interferometry to measure a second misalignment of the first and second substrates based on a second detected misalignment of the third and fourth alignment marks.

Example 1. A method of measuring misalignment between substrates, the method including: directing X-rays to a first substrate and to a second substrate in a bonding configuration prior to bonding together, the directing including directing the X-rays to a first alignment mark and to a third alignment mark in the first substrate and to a second alignment mark and to a fourth alignment mark in the second substrate; detecting fluorescent X-rays emitted from the first alignment mark and from the second alignment mark to measure a first misalignment of the first substrate with respect to the second substrate based on a first detected misalignment of the first alignment mark with respect to the second alignment mark; and detecting at least some of the X-rays transmitted through the first substrate and through the second substrate using X-ray Talbot-Lau interferometry to measure a second misalignment of the first substrate with respect to the second substrate based on a second detected misalignment of the third alignment mark with respect to the fourth alignment mark.

Example 2. The method of example 1, where the first alignment mark, the second alignment mark, the third alignment mark, and the fourth alignment mark include a metal.

Example 3. The method of one of examples 1 or 2, where the metal includes at least one of copper (Cu), tungsten (W), cobalt (Co), ruthenium (Ru), or molybdenum (Mo).

Example 4. The method of one of examples 1 to 3, where the first detected misalignment is detected by a first detector sensitive to the fluorescent X-rays to measure an intensity of the fluorescent X-rays related to a thickness of the metal, and where the second detected misalignment is detected by a second detector sensitive to the X-rays to measure an intensity of the X-rays transmitted relative to a TL interferometric pattern at the second detector.

Example 5. The method of one of examples 1 to 4, where the first alignment mark and the third alignment mark are located at a top surface of the first substrate and the second alignment mark and the third alignment mark are located at a top surface of the second substrate.

Example 6. The method of one of examples 1 to 5, where the top surface of the first substrate faces the top surface of the second substrate, or where the top surface of the first substrate faces the X-rays directed to the first substrate.

Example 7. A method of measuring misalignment between substrates, the method including: directing X-rays to a first substrate and to a second substrate in a bonding configuration prior to bonding together, the directing including directing the X-rays to a first alignment mark in the first substrate and to a second alignment mark in the second substrate; detecting fluorescent X-rays emitted from the first substrate and from the second substrate in response to the X-rays irradiating the first alignment mark and the second alignment mark; and measuring a first misalignment of the first alignment mark with respect to the second alignment mark based at least in part on a wavelength of the fluorescent X-rays corresponding to a metal in the first alignment mark and in the second alignment mark.

Example 8. The method of example 7, further including: discriminating the wavelength to measure the first misalignment based on the metal, where the metal includes at least one of copper (Cu), tungsten (W), cobalt (Co), ruthenium (Ru), or molybdenum (Mo).

Example 9. The method of one of examples 7 or 8, where the first misalignment is detected by a first detector sensitive to the fluorescent X-rays to measure an intensity of the fluorescent X-rays related to a thickness of the metal.

Example 10. The method of one of examples 7 to 9, where the first detector is a silicon drift detector (SDD).

Example 11. The method of one of examples 7 to 10, where the first alignment mark and the second alignment mark include a common material.

Example 12. A method of measuring misalignment between substrates, the method including: directing X-rays to a first substrate and to a second substrate in a bonding orientation for subsequent bonding to each other; transmitting the X-rays through a first alignment mark in the first substrate and through a second alignment mark in the second substrate using an X-ray Talbot-Lau interferometer, where the first alignment mark and the second alignment mark include a first Moiré interferometric grating pair; and measuring a first misalignment of the first substrate with respect to the second substrate based on detecting a first detected misalignment of the first alignment mark with respect to the second alignment mark using a first interferometric pattern and a second interferometric pattern associated with the first Moiré interferometric grating pair, the detecting the first detected misalignment including measuring a first displacement of the first interferometric pattern in a first direction and a second displacement of the second interferometric pattern in a second direction opposite the first direction.

Example 13. The method of example 12, where the first detected misalignment is linearly related to a first sum of absolute values of the first displacement and the second displacement, and where the first misalignment is at least 10 times smaller than the first sum.

Example 14. The method of one of examples 12 or 13, where the first Moiré interferometric grating pair is aligned to a beam splitter grating of the X-ray Talbot-Lau interferometer.

Example 15. The method of one of examples 12 to 14, further including: transmitting the X-rays through a third alignment mark in the first substrate and a fourth alignment mark in the second substrate using the X-ray Talbot-Lau interferometer, where the third alignment mark and the fourth alignment mark include a second Moiré interferometric grating pair; and measuring a second misalignment of the first substrate with respect to the second substrate based on measuring a second detected misalignment of the third alignment mark with respect to the fourth alignment mark using a third interferometric pattern and a fourth interferometric pattern associated with the second Moiré interferometric grating pair, the measuring the second detected misalignment including measuring a third displacement of the third interferometric pattern in the first direction and a fourth displacement of the fourth interferometric pattern in the second direction.

Example 16. The method of one of examples 12 to 15, where the second misalignment is linearly related to a second sum of absolute values of the third displacement and the fourth displacement, and where the second misalignment is at least 50 times smaller than the second sum.

Example 17. The method of one of examples 12 to 16, where a first lower limit of detection for the first Moiré interferometric grating pair is equal to a Talbot fringe period of an analyzer grating of the X-ray Talbot-Lau interferometer divided by a first Moiré magnification factor of the first Moiré interferometric grating pair, and where a first upper limit of detection for the first Moiré interferometric grating pair is equal to

$$\frac{{p}_{n} {p}_{n}^{′}}{2 ( {p}_{n} + {p}_{n}^{′} )}$$

where pₙ is a first pitch of the first alignment mark and p′ₙ is a second pitch of the second alignment mark.

Example 18. The method of one of examples 12 to 17, where a second lower limit of detection for the second Moiré interferometric grating pair is equal to the Talbot fringe period divided by a second Moiré magnification factor of the second Moiré interferometric grating pair, and where a second upper limit of detection for the second Moiré interferometric grating pair is equal to

$$\frac{{p}_{m} {p}_{m}^{′}}{2 ( {p}_{m} + {p}_{m}^{′} )} ,$$

where pₘ is a third pitch of the third alignment mark and pin is a fourth pitch of the fourth alignment mark.

Example 19. The method of one of examples 12 to 18, where the first upper limit of detection is greater than the second lower limit of detection.

Example 20. The method of one of examples 12 to 19, where the X-rays are concurrently transmitted through the first Moiré interferometric grating pair and the second Moiré interferometric grating pair.

Example 21. A method of measuring misalignment between semiconductor substrates, the method including: transmitting first X-rays, using an X-ray Talbot-Lau (TL) interferometer, through a first substrate and through a second substrate in a bonding configuration for subsequent bonding to each other, including transmitting the first X-rays through a first alignment mark in the first substrate and through a second alignment mark in the second substrate to generate second X-rays; transmitting the second X-rays through a TL phase grating and through a TL analyzer grating to generate third X-rays; and receiving the third X-rays at an X-ray detector to measure a first misalignment of the first substrate with respect to the second substrate based on detecting a first detected misalignment of the first alignment mark with respect to the second alignment mark using the X-ray detector.

Example 22. The method of example 21, where receiving the third X-rays at the X-ray detector further includes: performing a line scan by moving one of the TL phase grating or the TL analyzer grating over the first alignment mark and the second alignment mark; recording a line scan signal from an output of the X-ray detector while the X-ray detector receives the third X-rays during the line scan; and detecting the first detected misalignment based on the line scan signal.

Example 23. The method of one of examples 21 or 22, where detecting the first detected misalignment based on the line scan signal further includes: using a first stored library of reference line scan signals that are indexed to calibrated misalignment values to match the line scan signal to the first detected misalignment.

Example 24. The method of one of examples 21 to 23, where the X-ray detector includes a silicon drift detector (SDD).

Example 25. The method of one of examples 21 to 24, where receiving the third X-rays at the X-ray detector further includes: generating image data of the first alignment mark and the second alignment mark using the X-ray detector, where the X-ray detector is a flat panel X-ray image detector; and detecting the first detected misalignment based on the image data, including using a second stored library of reference image data that are indexed to calibrated misalignment values to match the image data to the first detected misalignment.

Example 26. The method of one of examples 21 to 25, where the first alignment mark includes a first Moiré grating element and the second alignment mark includes a second Moiré grating element, where the first Moiré grating element and the second Moiré grating element together form a Moiré interferometric grating pair, and where the second X-rays include a Moiré interferometric pattern.

While this disclosure has been described with reference to illustrative implementations, this description is not intended to be construed in a limiting sense. Various modifications and combinations of the illustrative implementations, as well as other implementations, will be apparent to persons skilled in the art upon reference to the description. It is therefore intended that the appended claims encompass any such modifications or implementations.

What is claimed is:

1. A method of measuring misalignment between substrates, the method comprising:
directing X-rays to a first substrate and to a second substrate in a bonding configuration prior to bonding together, the directing including directing the X-rays to a first alignment mark and to a third alignment mark in the first substrate and to a second alignment mark and to a fourth alignment mark in the second substrate;
detecting fluorescent X-rays emitted from the first alignment mark and from the second alignment mark to measure a first misalignment of the first substrate with respect to the second substrate based on a first detected misalignment of the first alignment mark with respect to the second alignment mark; and
detecting at least some of the X-rays transmitted through the first substrate and through the second substrate using X-ray Talbot-Lau interferometry to measure a second misalignment of the first substrate with respect to the second substrate based on a second detected misalignment of the third alignment mark with respect to the fourth alignment mark.

2. The method of claim 1, wherein the first alignment mark, the second alignment mark, the third alignment mark, and the fourth alignment mark comprise a metal.

3. The method of claim 2, wherein the metal comprises at least one of copper (Cu), tungsten (W), cobalt (Co), ruthenium (Ru), or molybdenum (Mo).

4. The method of claim 2, wherein the first detected misalignment is detected by a first detector sensitive to the fluorescent X-rays to measure an intensity of the fluorescent X-rays related to a thickness of the metal, and wherein the second detected misalignment is detected by a second detector sensitive to the X-rays to measure an intensity of the X-rays transmitted relative to a TL interferometric pattern at the second detector.

5. The method of claim 1, wherein the first alignment mark and the third alignment mark are located at a top surface of the first substrate and the second alignment mark and the third alignment mark are located at a top surface of the second substrate.

6. The method of claim 5, wherein the top surface of the first substrate faces the top surface of the second substrate, or wherein the top surface of the first substrate faces the X-rays directed to the first substrate.

7. A method of measuring misalignment between substrates, the method comprising:
directing X-rays to a first substrate and to a second substrate in a bonding configuration prior to bonding together, the directing including directing the X-rays to a first alignment mark in the first substrate and to a second alignment mark in the second substrate;
detecting fluorescent X-rays emitted from the first substrate and from the second substrate in response to the X-rays irradiating the first alignment mark and the second alignment mark; and
measuring a first misalignment of the first alignment mark with respect to the second alignment mark based at least in part on a wavelength of the fluorescent X-rays corresponding to a metal in the first alignment mark and in the second alignment mark.

8. The method of claim 7, further comprising:
discriminating the wavelength to measure the first misalignment based on the metal, wherein the metal comprises at least one of copper (Cu), tungsten (W), cobalt (Co), ruthenium (Ru), or molybdenum (Mo).

9. The method of claim 7, wherein the first misalignment is detected by a first detector sensitive to the fluorescent X-rays to measure an intensity of the fluorescent X-rays related to a thickness of the metal.

10. The method of claim 9, wherein the first detector is a silicon drift detector (SDD).

11. The method of claim 7, wherein the first alignment mark and the second alignment mark comprise a common material.

12. A method of measuring misalignment between substrates, the method comprising:
directing X-rays to a first substrate and to a second substrate in a bonding orientation for subsequent bonding to each other;
transmitting the X-rays through a first alignment mark in the first substrate and through a second alignment mark in the second substrate using an X-ray Talbot-Lau interferometer, wherein the first alignment mark and the second alignment mark comprise a first Moiré interferometric grating pair; and
measuring a first misalignment of the first substrate with respect to the second substrate based on detecting a first detected misalignment of the first alignment mark with respect to the second alignment mark using a first interferometric pattern and a second interferometric pattern associated with the first Moiré interferometric grating pair, the detecting the first detected misalignment including measuring a first displacement of the first interferometric pattern in a first direction and a second displacement of the second interferometric pattern in a second direction opposite the first direction.

13. The method of claim 12, wherein the first detected misalignment is linearly related to a first sum of absolute values of the first displacement and the second displacement, and wherein the first misalignment is at least 10 times smaller than the first sum.

14. The method of claim 12, wherein the first Moiré interferometric grating pair is aligned to a beam splitter grating of the X-ray Talbot-Lau interferometer.

15. The method of claim 12, further comprising:
transmitting the X-rays through a third alignment mark in the first substrate and a fourth alignment mark in the second substrate using the X-ray Talbot-Lau interferometer, wherein the third alignment mark and the fourth alignment mark comprise a second Moiré interferometric grating pair; and
measuring a second misalignment of the first substrate with respect to the second substrate based on measuring a second detected misalignment of the third alignment mark with respect to the fourth alignment mark using a third interferometric pattern and a fourth interferometric pattern associated with the second Moiré interferometric grating pair, the measuring the second detected misalignment including measuring a third displacement of the third interferometric pattern in the first direction and a fourth displacement of the fourth interferometric pattern in the second direction.

16. The method of claim 15, wherein the second misalignment is linearly related to a second sum of absolute values of the third displacement and the fourth displacement, and wherein the second misalignment is at least 50 times smaller than the second sum.
$$\frac{{p}_{n} {p}_{n}^{′}}{2 ( {p}_{n} + {p}_{n}^{′} )} {p}_{n} {p}_{n}^{′}$$

17. The method of claim 15, wherein a first lower limit of detection for the first Moiré interferometric grating pair is equal to a Talbot fringe period of an analyzer grating of the X-ray Talbot-Lau interferometer divided by a first Moiré magnification factor of the first Moiré interferometric grating pair, and
$$\frac{{p}_{n} {p}_{n}^{′}}{2 ( {p}_{n} + {p}_{n}^{′} )} {p}_{n} {p}_{n}^{′}$$
wherein a first upper limit of detection for the first Moiré interferometric grating pair is equal to, wherein is a first pitch of the first alignment mark and is a second pitch of the second alignment mark.
$$\frac{{p}_{m} {p}_{m}^{′}}{2 ( {p}_{m} + {p}_{m}^{′} )} {p}_{m} {p}_{m}^{′}$$

18. The method of claim 17, wherein a second lower limit of detection for the second Moiré interferometric grating pair is equal to the Talbot fringe period divided by a second Moiré magnification factor of the second Moiré interferometric grating pair, and
$$\frac{{p}_{m} {p}_{m}^{′}}{2 ( {p}_{m} + {p}_{m}^{′} )} {p}_{m} {p}_{m}^{′}$$
wherein a second upper limit of detection for the second Moiré interferometric grating pair is equal to, wherein is a third pitch of the third alignment mark and is a fourth pitch of the fourth alignment mark.

19. The method of claim 18, wherein the first upper limit of detection is greater than the second lower limit of detection.

20. The method of claim 15, wherein the X-rays are concurrently transmitted through the first Moiré interferometric grating pair and the second Moiré interferometric grating pair.

21. A method of measuring misalignment between semiconductor substrates, the method comprising:
transmitting first X-rays, using an X-ray Talbot-Lau (TL) interferometer, through a first substrate and through a second substrate in a bonding configuration for subsequent bonding to each other, including transmitting the first X-rays through a first alignment mark in the first substrate and through a second alignment mark in the second substrate to generate second X-rays;
transmitting the second X-rays through a TL phase grating and through a TL analyzer grating to generate third X-rays; and
receiving the third X-rays at an X-ray detector to measure a first misalignment of the first substrate with respect to the second substrate based on detecting a first detected misalignment of the first alignment mark with respect to the second alignment mark using the X-ray detector.

22. The method of claim 21, wherein receiving the third X-rays at the X-ray detector further comprises:
performing a line scan by moving one of the TL phase grating or the TL analyzer grating over the first alignment mark and the second alignment mark;
recording a line scan signal from an output of the X-ray detector while the X-ray detector receives the third X-rays during the line scan; and
detecting the first detected misalignment based on the line scan signal.

23. The method of claim 22, wherein detecting the first detected misalignment based on the line scan signal further comprises:
using a first stored library of reference line scan signals that are indexed to calibrated misalignment values to match the line scan signal to the first detected misalignment.

24. The method of claim 22, wherein the X-ray detector comprises a silicon drift detector (SDD).

25. The method of claim 21, wherein receiving the third X-rays at the X-ray detector further comprises:
generating image data of the first alignment mark and the second alignment mark using the X-ray detector, wherein the X-ray detector is a flat panel X-ray image detector; and
detecting the first detected misalignment based on the image data, including using a second stored library of reference image data that are indexed to calibrated misalignment values to match the image data to the first detected misalignment.

26. The method of claim 21, wherein the first alignment mark comprises a first Moiré grating element and the second alignment mark comprises a second Moiré grating element, wherein the first Moiré grating element and the second Moiré grating element together form a Moiré interferometric grating pair, and wherein the second X-rays comprise a Moiré interferometric pattern.
